(19) United States
(12) Patent Application Publication
(10) Pub. No.: US 2007/0256794 A1
(43) Pub. Date: Nov. 8, 2007

(54) Method for extracting a foam support ring from a tire

(75) Inventor: Jean-Jacques Azam, Clermont-Ferrand (FR)

Correspondence Address: BUCHANAN, INGERSOLL & ROONEY PC, POST OFFICE BOX 1404, ALEXANDRIA, VA, 22313-1404, US

(73) Assignee: MICHELIN RECHERCHE ET TECHNIQUE S.A., SWITZERLAND

(21) Appl. No.: 11/790,846

(22) Filed: Apr. 27, 2007

(30) Foreign Application Priority Data
May 5, 2006 (FR) 06/04167

(51) Int. Cl. B60C 25/00

(52) U.S. Cl. 157/1.1

(57) ABSTRACT

A foam support ring is extracted from a tire by pushing radially inwardly against a portion of the tire's tread until the support ring is deformed to such an extent that a space is formed between tire beads and the outer periphery of a portion of the support ring. A tool is inserted into that space to keep the space open when the radial force is released. That enables a first roller to be inserted into the space and displaced relative to two other rollers that have been inserted in an internal area bordered by the beads, in order to further deform the support ring to a U-shape that can be easily extracted from the tire.

The present application claims priority under 35 U.S.C. § 119 to patent application Ser. No. 06/04167 filed in France on May 5, 2006, the content of which is hereby incorporated by reference.

### BACKGROUND

The invention relates generally to tires, especially running systems able to run at reduced pressure and intended to equip motor vehicles. These systems comprise a rim provided with a valve, a tire, and a support ring of approximately toroidal shape. In particular the invention relates to the extraction of the support rings from the tires.

This support ring, more commonly termed a foam support ring, is generally made of closed-cell cellular rubber. It is intended to take the load in the event of a loss of tire pressure. The cells may, in some cases, contain a pressurized gas.

The invention is more specifically concerned with the operations of assembling and disassembling a system containing a foam support ring.

To this end, assembly methods and machines able to insert the foam support ring into the tire have been developed, these being based on machines and methods known and used for introducing the curing bag into a tire and as described, by way of example, in Bines et al. U.S. Pat. No. 1,759,681 or alternatively as illustrated in FIG. 1.

These machines comprise a chassis 5 on which rollers 1, 2 and 3 are mounted, these rollers being free to rotate about their respective axes Y₁Y′₁, Y₂Y′₂, Y₃Y′₃, the axes Y₁Y′₁, Y₂Y′₂ and Y₃Y′₃ being mutually parallel. A first roller 1 is able to move along an axis ZZ′, and the other two rollers move, symmetrically relative to the axis ZZ′, along an axis XX′ perpendicular to the axis ZZ′. The assembly machine according to the known prior art and illustrated in FIG. 1 has its axis ZZ′ positioned vertically and its axis XX′ positioned horizontally.

A foam support ring B is installed in a tire in the conventional way by compressing the support ring using the rollers as illustrated in FIG. 5. The rollers 2 and 3 are brought into contact with the internal circumference of the support ring and the roller 1 is positioned on the external circumference of the support ring. The roller 1 is then lowered in such a way as to drive the support ring between the rollers 2 and 3 and cause it to adopt a U-shape as illustrated in U.S. Pat. No. 1,759,681 or alternatively in FIG. 5 of the present application.

The tire is then positioned around the support ring and, by maneuvering the rollers appropriately, the support ring is released into the interior space of the tire.

This method is well known for carrying out the operations of installing a curing bag and can be adapted with no particular difficulty to the installing of foam support rings, particularly to the assembly of systems intended for touring cars in which the seat diameter of the rim generally ranges between 13″ and 19″.

Equivalent insertion means are also described in applications EP 1 354 730 (corresponding to U.S. Publication 2003/0193114) or alternatively in application WO 95/33628 (corresponding to U.S. Pat. No. 5,836,366). These devices do not address the problem associated with disassembly and extraction of the support ring.

The means described in application FR 2 319 503 are intended for extracting a solid chamber from the tire. However, their use requires a great deal of care to be taken, given that the insert is pulled out using a puller element similar to a gripper, the pulling forces of which are liable to injure and damage the insert.

However, the above-described means were not designed to facilitate the operation of disassembly. Specifically, the curing bag is generally extracted using suitable pulling grippers, once said chamber has been evacuated, so as to reduce its size.

It will be noted that one of the specific features of a foam support ring is that its volume is substantially constant at atmospheric pressure.

A method for fitting (installing) and extracting inserts is disclosed by way of example in patent application EP 0 010 004-A1 (corresponding to Jacquemin U.S. Pat. No. 4,251,906). This publication describes a machine and a method involving pusher bars able to eject the insert by exerting axial thrust on the sidewall of the insert.

This method may prove particularly effective for large-sized inserts and tires which have enough rigidity to be able to withstand the necessary pulling forces, but proves ill-suited to systems comprising a relatively elastic foam support ring, as is the case in passenger cars.

Furthermore, this method presents the disadvantage of deforming the foam support ring in the axial direction, and the effect of this is to introduce high torsional stresses into the sole of the foam support ring. These forces may detract from the quality of the bond between the support ring and the sole, or may even degrade this bond.

It is an object of the present invention to provide users of foam support rings intended for touring cars with a method and tooling allowing use of the machine to extract the foam ring from a tire.

### SUMMARY OF PREFERRED EMBODIMENT

The preferred operating procedure involves the following steps:
the tread strip of the tire (P) is pressed firmly in the radial direction using a means able to punch the tread surface until the top of the foam support ring is pushed radially inside the perimeter defined by the beads of the tire so as to form a space (E) between the top of the foam support ring and the beads of the tire,
a means (F) able to keep the space (E) clear for access when the force applied in the previous step is released, is introduced into the space (E),
the force applied to the tread strip is released,
a first roller of axis Y₁Y′₁ is introduced axially into the space (E), and a second and third roller of axes Y₂Y′₂ and Y₃Y′₃ respectively are introduced into the interior space defined by the internal diameter of the foam support ring, the axes Y₁Y′₁, Y₂Y′₂ and Y₃Y′₃ being mutually parallel,
once the holding means (F) has been extracted, the first roller is moved relative to the second and to the third rollers along an axis situated substantially mid-way between the two axes Y₂Y′₂ and Y₃Y′₃ and perpendicular to the plane formed by the axes Y₂Y′₂ and Y₃Y′₃ so as to drive the support ring between the second and third rollers (2 and 3) and cause it to adopt a U-shape,
the tire is disengaged and the foam support ring is released by maneuvering the rollers (1, 2, 3) and the tire relative to each other.

The proposed tooling F is formed of two mutually parallel forks joined by one of their ends to a head equipped with an end forming handles.

In this way, it is possible to use the same machine for fitting and removing the foam support ring, particularly in the case of support rings and tires intended to be used in passenger cars. In addition, this method proves to be relatively simple and the special tooling F required to implement it is inexpensive and easy to use.

The support ring is folded in a radial plane, thus avoiding any torsional loadings on the sole and any damage to the interface between the sole and the support ring during the extraction operation.

### BRIEF DESCRIPTION OF DRAWINGS

The description which follows relies on FIG. 1 to illustrate a machine to be used in performing the method, and FIGS. 2-6 to illustrate the various steps in the method according to the invention, and in which:

FIG. 1 depicts a perspective schematic view of a prior art machine suitable for installing foam support rings into tires,

FIG. 2 depicts a schematic view of the FIG. 1 machine being used, according to the invention, to extract a support ring from a tire, particularly at the end of the step of forming a space and introducing tooling into the space,

FIG. 3 depicts a schematic view of the machine at the end of the step that consists in introducing rollers into the space,

FIG. 4 depicts a schematic view of the machine at the end of the step of shaping the foam support ring into a U,

FIG. 5 depicts a schematic view of the machine once the tire has been disengaged from the support ring (and which is similar to its appearance when the machine is used for installing a foam ring support according to the prior art and is thus labeled as “prior art” for that reason only),

FIG. 6 depicts a schematic view of the tooling according to the invention intended for holding the support ring in place during the steps of FIGS. 2 and 3.

### DETAILED DESCRIPTION OF A PREFERRED EMBODIMENT

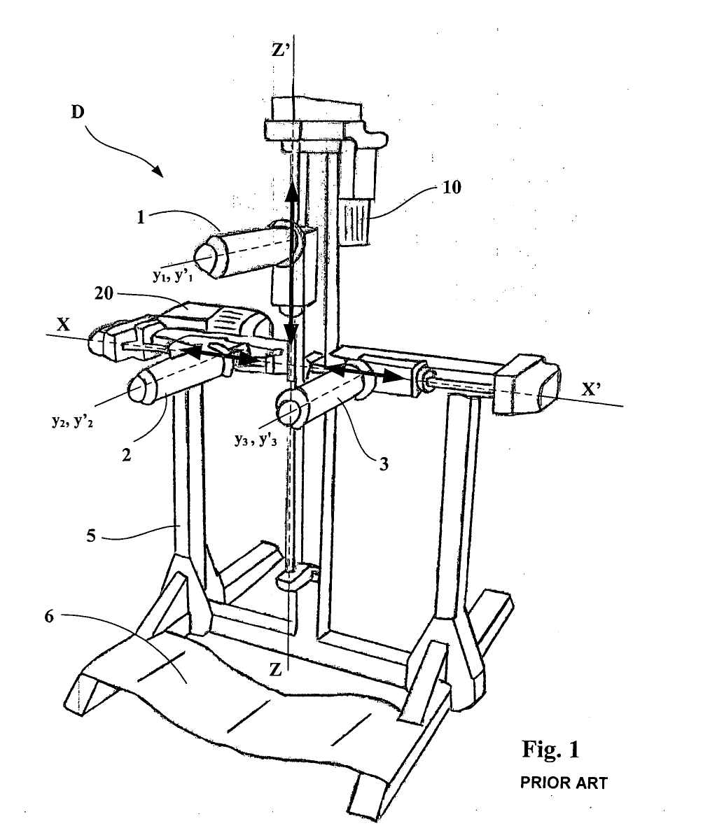

The prior art machine D illustrated in FIG. 1, which preferably is to be used for extracting a foam support ring from a tire according to the invention, comprises a chassis 5 presenting a first motorized vertical axis ZZ′ along which a first roller 1, of horizontal axis Y₁Y′₁, oriented perpendicular to the axis ZZ′, moves under the action of an electric motor 10.

A second motorized axis XX′, positioned horizontally and perpendicular to the axis ZZ′, supports a second (2) and a third (3) roller of axes Y₂Y′₂ and Y₃Y′₃ respectively, the said axes being parallel to the axis Y₁Y′₁. The rollers 2 and 3 move along the axis XX′ symmetrically relative to the axis ZZ′ under the action of the motor 20.

A curved support 6, positioned at the base of the chassis, accepts a tire from whose interior the foam support ring is to be extracted. The tire's axis is parallel to the axes of the rollers 1, 2, 3.

The subsequent figures illustrate the various steps in the method according to the invention.

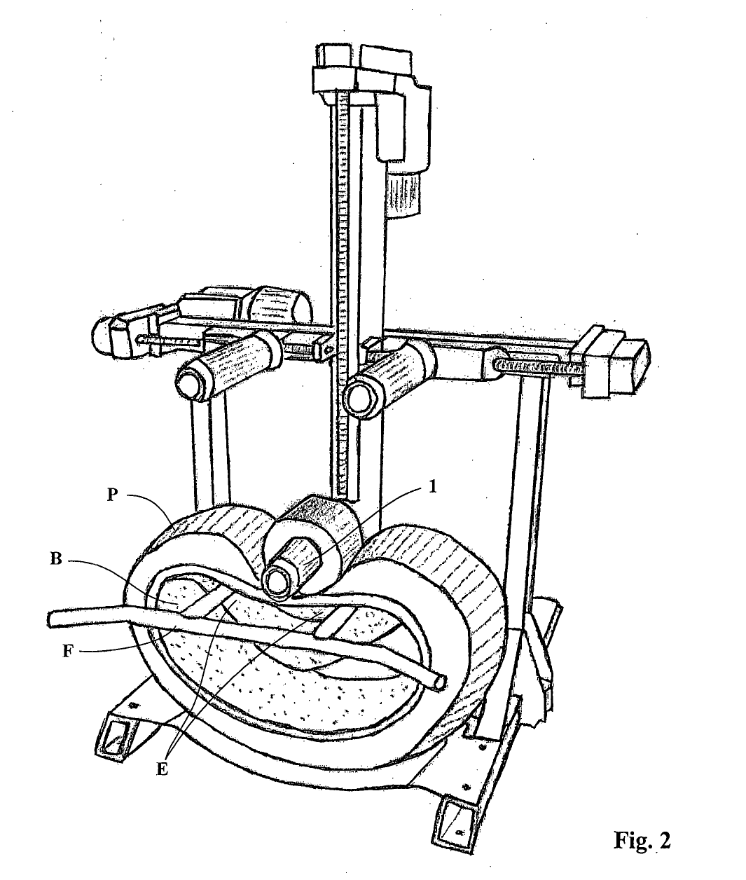

A first step is to lower the roller 1 onto the tread surface of the tire so as to apply a radially inward force in order to punch-in the surface radially inwardly until the top T of the foam support ring S carried by the tire is pushed radially inside the perimeter defined by the beads of the tire. Thus, there is formed a space E between the top of the foam support ring and the beads of the tire, which space E has to be large enough to receive a holding tool, such as a fork F according to the invention, which is illustrated in FIG. 2.

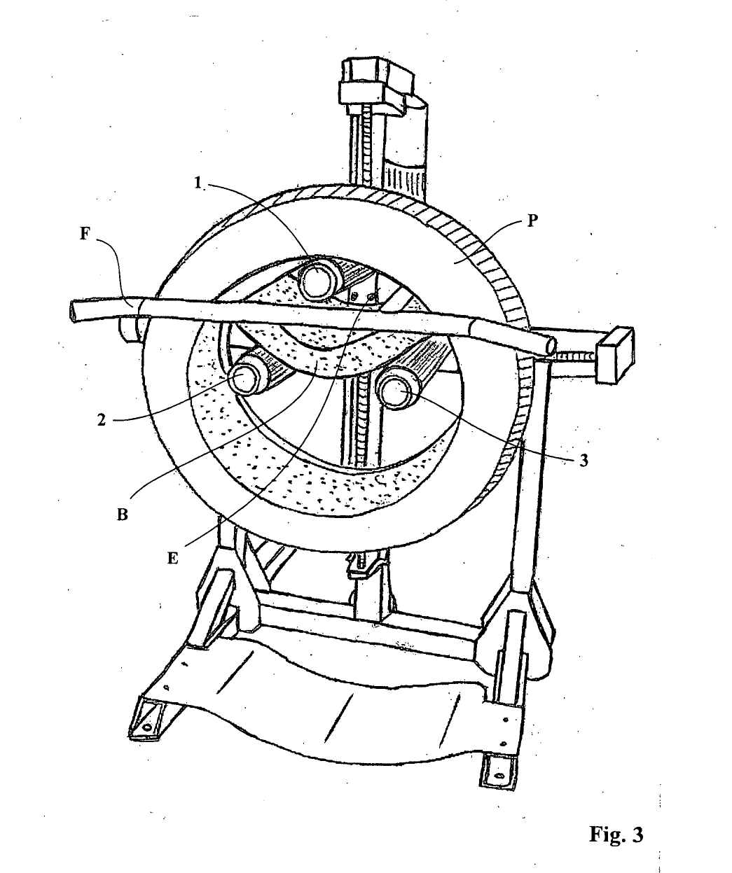

Once the fork has been engaged between the beads and the top of the foam support ring, the roller 1 is raised until the tire more or less reverts to its normal shape since releasing the radially inward force also releases the elastic stresses. The fork then allows enough of the space E to remain to be possible for the operator to manipulate the tire in order to introduce the roller 1 into the space E between the two branches (101 and 102) of the fork. The position of the second and third rollers (2 and 3) is adjusted accordingly so that they slip into the internal space defined by the interior diameter of the support ring as is illustrated in FIG. 3.

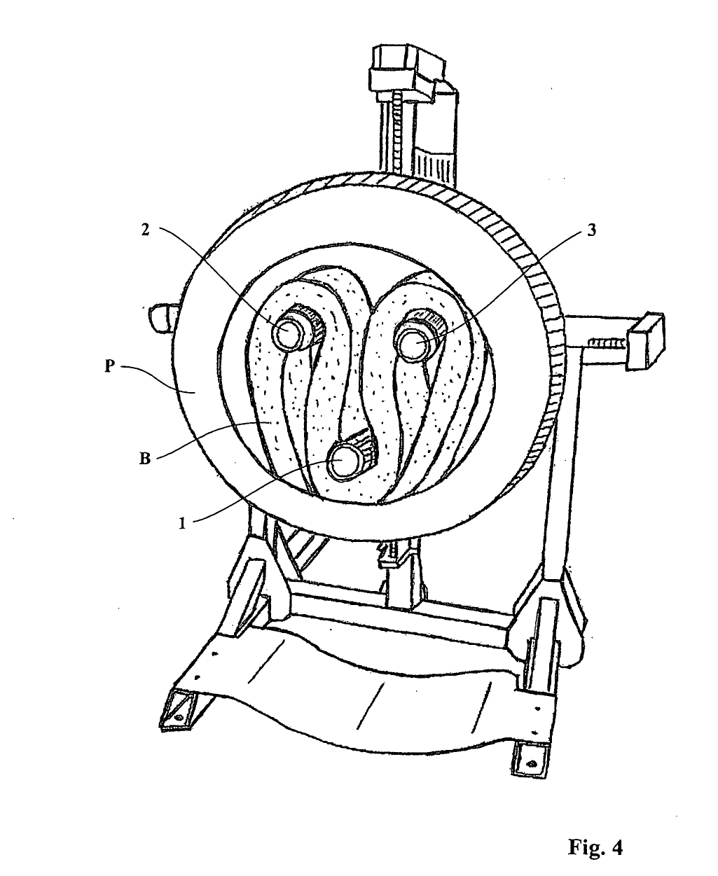

It is then possible to remove the fork and to lower the roller 1 between the rollers 2 and 3 so as to drive the foam support ring generally radially inwardly in a direction perpendicular to a plane defined by the second and third axes, at a location midway between those axes. The foam support ring travels past the plane and adopts the characteristic U-shape by playing on the elastic properties of the support ring as illustrated in FIG. 4.

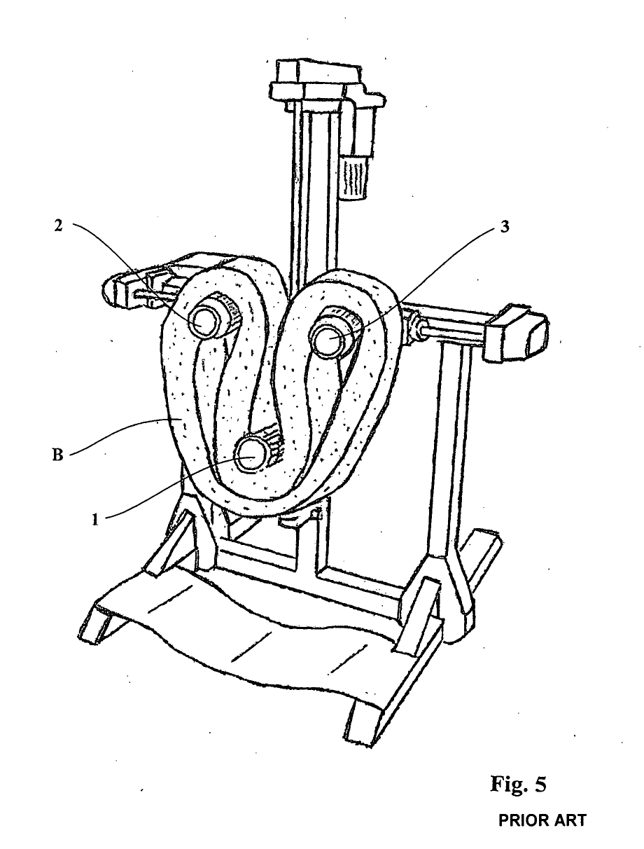

In this configuration, it is easy to disengage the beads at the bottom by tilting the tire appropriately, then to disengage the beads in the top part by lifting the tire up in order to end up in the configuration as illustrated in FIG. 5. (When the prior art machine D is used to carry out the present invention, FIG. 5 would correspond to the appearance of a foam support ring B on the machine as the machine is installing a support ring into a tire.)

All that then remains is for the roller 1 to be raised in order to release the foam support ring from the machine.

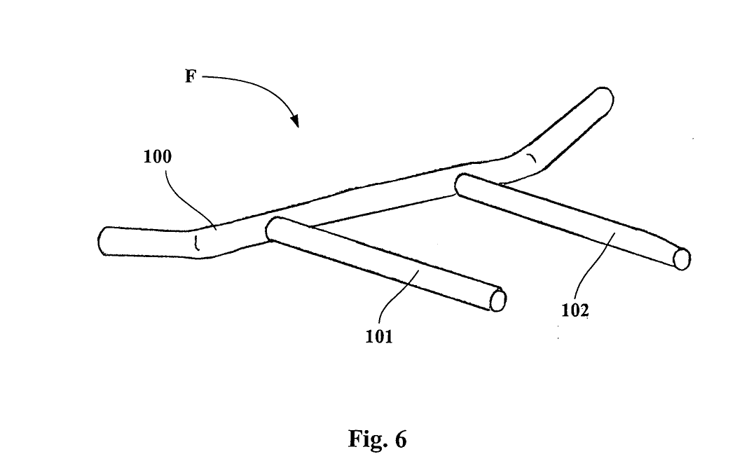

The fork F, as illustrated by FIG. 6, is formed of two mutually parallel branches 101 and 102 each connected at one of their ends to a fork head 100. The fork head is formed of an elongate bar to which each of the two branches 101 and 102 is welded at right angles. The two ends of the fork head are configured in such a way that they can be grasped by an operator with his hands in order to facilitate insertion and extraction of the fork during the cycle of extracting the support ring.

The separation between the two branches needs to be designed such that the roller 1 can slip between the two branches. In practice, this separation ranges between 20 and 30 cm, depending on whether it is small-diameter or large-diameter systems being processed.

Although it is preferred to use rollers (i.e., rotary cylinders) 1, 2 and 3, there could instead be used stationary (i.e., non-rotary) cylinders.

What is claimed is:

1. A method of extracting a foam support ring from an interior space of a tire which includes a tread and beads, comprising the steps of:
A. applying a radially inward force against a portion of the tire tread until a radially outer surface of a portion of the foam support ring becomes displaced radially inwardly of the beads, and a space is formed between the beads and the radially outer surface of the foam support ring;
B. inserting a holding tool into the space to keep the space from fully closing in the absence of the radially inward force;
C. releasing the radially inward force;
D. introducing a first cylinder axially into the space, the first cylinder having a first axis oriented substantially parallel to the tire axis,
E. introducing second and third cylinders into an interior space bordered by the foam support ring, the second and third cylinders having second and third axes, respectively, oriented substantially parallel to the first axis;
F. extracting the holding tool from the space;
G. moving the first cylinder relative to second and third cylinders generally radially inwardly in a direction substantially perpendicular to a plane defined by the second and third axes and at a location substantially midway between the second and third axes, to move the foam support ring past the plane, whereby a portion of the foam support ring engaged by the cylinders adopts a U-shape; and
H. maneuvering the tire and the rollers relative to one another to release the foam support ring from the tire.

2. The method according to claim 1 wherein the first, second and third cylinders are mounted on a chassis, wherein the second and third cylinders are movable relative to the chassis in a direction within the plane, and the first cylinder is movable relative to the chassis in a direction perpendicular to the plane.

3. The method according to claim 1 wherein the radially inward force of step A is applied by the first cylinder.

4. The method according to claim 1 wherein the holding tool includes a pair of parallel branches and a fork head attached to two adjacent ends of the branches, wherein step B comprises inserting the branches into the space.

5. The method according to claim 4 wherein the first cylinder is introduced between the two branches in step D.

6. The method according to claim 1 wherein the support ring is formed of cellular rubber.

7. The method according to claim 1 wherein the first, second, and third cylinders comprise rollers.

8. The method according to claim 1 wherein steps D and E are performed simultaneously.
